(19) United States
(12) Patent Application Publication
(10) Pub. No.: US 2007/0222577 A1
(43) Pub. Date: Sep. 27, 2007

(54) Interactive Home Security System

(76) Inventors: Wayne Martin Wilson, Tulsa, OK (US); Rodney S Twyman, Tulsa, OK (US)

Correspondence Address: WAYNE M. WILSON, 11433 E. 20TH ST., # A, TULSA, OK, 74128, US

(21) Appl. No.: 11/277,512

(22) Filed: Mar. 26, 2006

(51) Int. Cl. G08B 19/00; G08B 13/00

(52) U.S. Cl. 340/521; 340/541

(57) ABSTRACT

An Interactive Home Security System with multiple features including: 1. An intercom 2. Motion detector lights 3. Various alarm sounds 4. Recorded play back 5. Recorded voice warning. This integrated system is a simplified consolidated construction of several home security system components. The controls used for various settings and to operate the system are all in one console unit that is stationed inside the house. The features include motion detector lights, an alarm system that sends out a siren or voice recording, recording of sounds in the alert area to be played back at a later time and an intercom system to communicate with people around the house. The complete system can expand to cover more of the living area depending on how many components are assembled.

### CROSS-REFERENCE TO RELATED APPLICATIONS

This application claims the benefit of provisional patent application Ser. No. 60/666,980, filed Mar. 31, 2005 by the present inventors.

### FEDERALLY SPONSORED RESEARCH

Not Applicable

### SEQUENCE LISTING

Not Applicable

### BACKGROUND OF THE INVENTION

1. Field of Invention

This invention relates to a consolidation of various home security system components that involve various functions including motion detection lights, intercom and alarms that emit various sounds and record sounds at the alert area.

2. Prior Art

No relevant Prior Art was found however these types of systems available today are separate and have to be purchase and installed as separate systems. When they are purchased this way they begin to cost more money. They also will have different and separate controls. The Prior Art systems that were discovered consist of motion detector systems and various types of alarm systems each addressing specific types of functions. None of the Prior Art indicated a lower cost integrated or consolidated system having multi-feature functions. The various systems that are available for home security include intercom, motion detector lights, various alarms. These alarms give different sounds when set off and may record sounds at the alert area. In conclusion, insofar as we are aware, there is no home security system that integrates all of these functions into one system. They are all made in China for cost effective reasons. However the homeowner's cost effective price may not be addressed. With an integrated system the construction and price would be less costly because it would be more cost effective construction. The controls would be simpler because they would be in one unit. An integrated system that was made easy to install would be easier for the homeowner to purchase and own.

### Objects and Advantages

Accordingly, several objects and advantages of our invention are the integration of several systems into one unit. This makes it simpler to construct. In order to overcome the limitations of the current prior art that was discovered, it is required that an integrated home security system be developed. This should allow for a cost-effective multifunctional system. A homeowner can install our invention and this obviously will make the cost and price even lower. Multiple features provide a comprehensive and affordable home security product. An intercom, motion detector lights, and alarms gives the homeowner a usable home security system. An intercom system gives the homeowner a usable way to communicate around the household and monitor the children. A motion detector and alarm monitors the alert area for intruders, gives warnings and records their activity. An alert area is anywhere outside the house that you want to watch but is usually the back of the house. Further objects and advantages of our invention will become apparent from consideration of the ensuing description.

### SUMMARY

In accordance with the present invention an interactive home security system has multiple features in an integrated construction. Various components will be purchased when the homeowner decides how large of a system is needed. Motion detector light units 12 and Speaker/Mic 14 units are installed outside of the house, i.e. Patio. Inside the house said Console 20 is plugged into a phone line on a table with a special connector. All controls are in the Console 20 so we call this system Interactive Home Security System. Various settings can be made at said Console to get system initiated. Console controls are also used to operate the system, as there are multiple features. This system allows the head of household or homemaker to purchase a low cost comprehensive home security system, have multiple security features, and know what's going around the household.

### DRAWINGS—FIGURES

FIG. 1 is an overall view of the entire system showing components outside and inside the house.

### DRAWINGS—REFERENCE NUMERALS

10 Phone Box Outside of House
12 Motion Detector light Unit
14 Speaker/Mic Only
16 Phone Lines
18 Phone
20 Console—Interactive Controls
22 Parallel Connector
24 Outside Parallel Connections

### DETAILED DESCRIPTION

The Interactive Home Security System consists of three major components, the Motion Detector Unit(s) 12, the Speaker/Mic Units 14 and the Console 20.

Motion Unit(s) 12—Self contained remotely mounted unit consisting of a motion detector, flood light(s), microphone and speaker. Inputs consist of standard house A/C voltage and a standard four line telephone input.

Speaker Unit(s) 14—Self contained remotely mounted unit consisting of a microphone and speaker. Inputs consist of standard house A/C voltage and a standard four-line telephone input.

Console 20—Integrated multi-function unit to receive and transmit audio/data signals between the Console and remote Motion Unit(s) 12 and Speaker Unit(s) 14. When activated by the Motion Unit 12 the Console 20 will trigger the pre-selected alarm response such as a recorded statement or siren to the remotely mounted Motion Unit(s) 12 and/or Speaker Unit(s) 14. In concurrence with the alarm response the Console 20 will also send a continuous ring to all telephones in the home to alert the homeowner. After a pre-selected time the alarm response will terminate and the Console 20 will begin recording from all remotely mounted units. At this time the homeowner will be able to monitor any sounds detected by the remote units and if desired reply real time to the intruder via the remote units speaker. Console 20 will also act as standard answering machine, intercom and cordless phone with all typical functions currently expected from these devices.

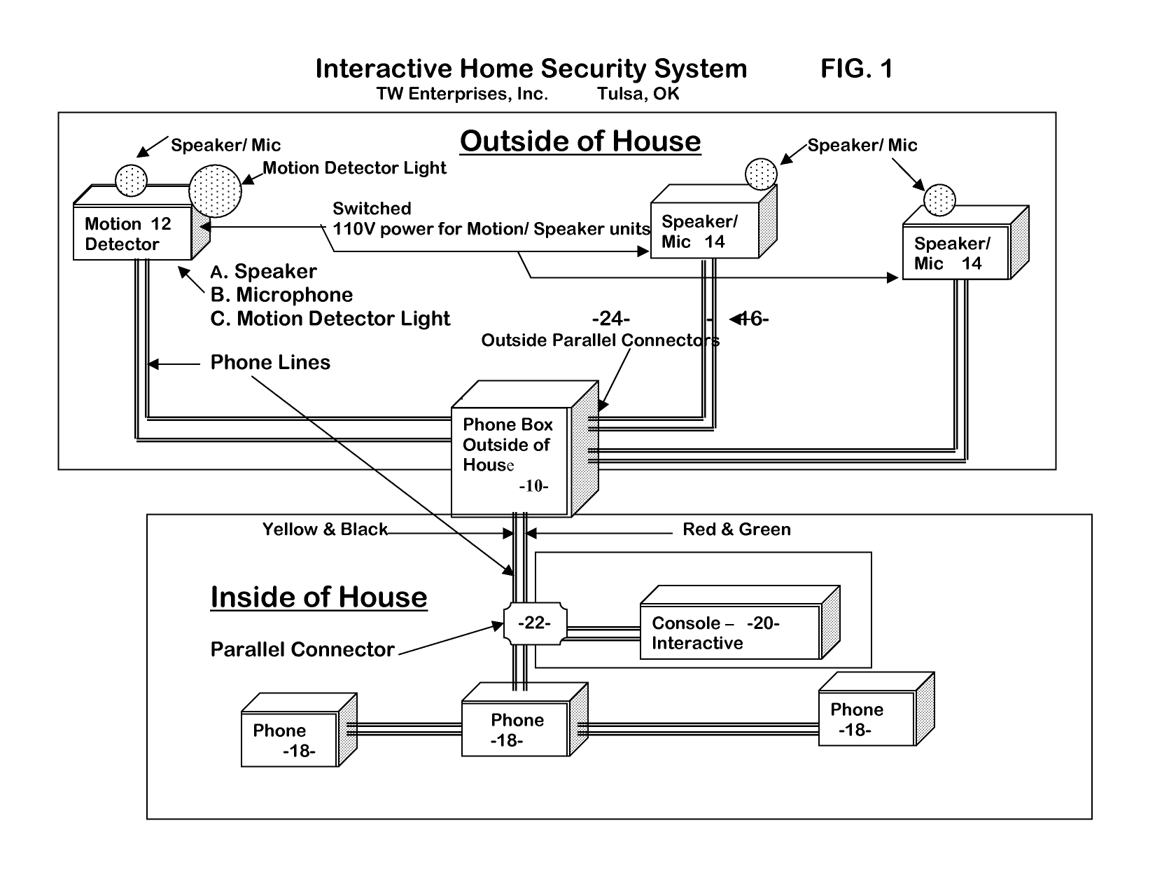

An Interactive Home Security System will be constructed as shown in FIG. 1. A homeowner should be able to do the installation. First the outside components will be installed. A Motion Unit(s) 12 and Speaker Unit(s) 14 will be installed with conventional 110-volt household power. Then all Units will be connected to Phone Box Outside of House 10 using regular Phone Lines 16. Telephone line has 4 wires (Yellow, Black, Red, and Green). It's the typical telephone line sold in the U.S. so all homes have this type of telephone line. These will be routed appropriately to secure them out of the way under the eaves of the house then down to the Phone Box 10 at the back of house. Motion Unit(s) 12 will be located to be the most effective if an intruder enters the alert area. Motion Unit(s) 12 and Speaker Unit(s) 14 (as desired) will be placed where people and children can hear and talk on the intercom. Connections to the Phone Box 10 will be a parallel connection. This means the same color of wires is connected. Inside the house Console 20 will be set on a table and connected to the phone line of the selected Phone 18. When the system is in the alarm or intercom mode full telephone function will be available allowing the homeowner to call for help.

Operation

Once the installation is complete Console 20 settings can be made. The time and date are Set and Selections for siren or recording are made. Interior Ring Phones Selection is made. To use the outgoing voice recording you must record it by pressing a Record Message function. If a women wishes, she can select a Voice Tone setting and the system will play the outgoing message at a lower tone. This may make this voice sound more robust like a man's voice. This outgoing message will probably be something like “Hey who goes there, I'm calling the police” or live Intercom interaction. To use an Intercom use Intercom Listen or Intercom Talk functions. To play back and erase recordings made of the alert area use a Play Back, Erase, Next and Prev functions.

Thus the reader will see that a person can use the intercom to monitor the children in the back yard or to talk to someone who's around the house. If someone goes on a trip they can check the system for alert setoffs remotely via call in or when they get back by using the Play Back function. The recorder will tell them what time and date the alert was set off and play any recordings made at that time in the alert area. With this system installed the homeowner will have a low cost comprehensive home security system with intercom, a siren, recording or live interaction for an alarm, and motion detector lights and all phones ring when alarm is set off by an intruder.

Accordingly, the scope of the invention should be determined not by the embodiment illustrated, but by the appended claims and their legal equivalents.

We claim:

1. An integrated interactive home security system comprising:
(a) a two-way intercom system with one or more matching speakers and microphones mounted outside the house.
(b) one or more motion detector light systems mounted outside said house that will turn on when said motion detector is set off by an intruder at the alert area.
(c) an alarm system that will play one of a plurality of sounds to said speakers when said motion detector is set off by said intruder at said alert area.

2. The interactive home security system of claim 1 with means for integrating said systems in a, b, and c above into one consolidated system with a console containing controls that will be operated from inside said house.

3. The interactive home security system of claim 1 with means for recording sounds at said alert area when said motion detector is set off by said intruder that can be played back at a later date.

4. The interactive home security system of claim 1 with means for recording voice at said console that can be played back or an alternate siren at said alert area to warn said intruder when said motion detector is set off by said intruder.
Whereby an interactive home security system will be available for the head of household or homeowner to purchase as a low cost comprehensive home security system that will have multiple security features and allow a usable way to communicate around the household and monitor the children.
